(19) United States
(12) Patent Application Publication
(10) Pub. No.: US 2026/0067488 A1
(43) Pub. Date: Mar. 5, 2026

(54) ENCODING AND DECODING FOR FACE VIDEOS

(71) Applicants: City University of Hong Kong, Kowloon (HK); Lingnan University, Tuen Mun (HK)

(72) Inventors: Sam Tak Wu Kwong, Tuen Mun (HK); Shiqi Wang, Kowloon (HK); Xiaona Li, Kowloon (HK)

(21) Appl. No.: 18/822,808

(22) Filed: Sep. 3, 2024

(51) Int. Cl. H04N 19/52; H04N 19/139; H04N 19/162; H04N 19/20; H04N 19/42

(52) U.S. Cl. CPC H04N 19/52; H04N 19/139; H04N 19/162; H04N 19/20; H04N 19/42

(57) ABSTRACT

There is provided an encoder for face videos, which includes a video codec for compressing an initial frame of a face video sequence, a compact feature extraction module for extracting a motion code and expression attributes across subsequent inter frames, and a feature encoding module for feature compression with feature-level inter prediction based on the motion code and the expression attributes.

### TECHNICAL FIELD

The present invention relates to encoders and decoders for face videos and related methods.

### BACKGROUND

Editable-emotion face video coding is an emerging yet pivotal topic, aimed at achieving ultra-low bitrate coding and communication while enabling editable-emotion interaction. This arises from the fact that while existing face video coding frameworks [2, 3, 23] are essential for achieving reasonable communication costs, they did not consider the emotion editing task. To address users' emotional requirements for decoded videos, emotion editing algorithms are typically applied to the transmitted videos. Clearly, the whole of process, encompassing both coding and emotion editing tasks, is cumbersome and lacks flexibility. Therefore, conducting semantic-level emotion editing directly within the bitstream become urgent and paramount. Though substantial progresses have been developed in face video coding [18, 25] and face video emotion editing [22, 36], there are still numerous challenges ahead. Firstly, the face video coding frameworks based on an end-to-end animation model [3, 29, 33, 34] may be capable of achieving ultra-low bitrate communication, as the motion information (e.g., landmark and key-point) is encoded as the transmitted symbols. However, they lack applicability in user-specified emotional editing scenarios. Secondly, the face emotion editing schemes [1, 31] can achieve the high-quality facial expression editing results by separating the expression from other information. However, they may lead to additional bitrate cost in face video communication due to high-dimensional and non-compact representations. As such, these existing schemes are not compatible with both ultra-low bitrate communication and editable emotion interaction.

### SUMMARY OF THE INVENTION

Exemplary embodiments of the invention propose editable-emotion face video coding frameworks, namely EmoCodec, which support both compact face representation for ultra-low bitrate coding and facial emotion control. The frameworks are delicately designed based upon an observation that when a person speaks, the coordinated movements of his/her various facial regions jointly determine the overall facial movement. Accordingly, the proposed frameworks use three-level motion information: (1) an ultra-compact face motion representation to lay the foundation for achieving the ultra-low bitrate video communication task, (2) two finer-grained motions (i.e., pose and expression) to facilitate accurately modeling the patterns of distribution between the real-world expression motion and its characteristics, and (3) semantic-level expression attributes to enable precise manipulation of emotions. Based on such hierarchical motion information, the frameworks can flexibly switch between ultra-low bitrate video reconstruction and user-specified emotion editing. The main contributions of the present disclosure can be summarized as follows,
The frameworks enjoy the desired advantages in ultra-compact feature representation and interpretable coding bitstream. As such, the proposed frameworks can support both ultra-low bitrate communication and editable-emotion interaction.
Given semantic-level emotional attributes, the user-specified expression latent code is generated by a conditional continuous normalizing flow mechanism, facilitating precise and random transitions across diverse emotion domains. Furthermore, the windowed smoothing scheme is incorporated to minimize the inter-frame jitter of generated videos.
Experiments exhibit significant bitrate reductions compared to VVC, with savings of 73.22% and 68.70% in DISTS and LPIPS metrics, respectively, across 30 testing sequences. Meanwhile, the frameworks offer accurate and flexible transitions in different emotional domains and intensities.

According to a first aspect of the invention, there is provided an encoder for face videos, which includes a video codec for compressing an initial frame of a face video sequence, a compact feature extraction module for extracting a motion code and expression attributes across subsequent inter frames, and a feature encoding module for feature compression with feature-level inter prediction based on the motion code and the expression attributes.

In some embodiments, the video codec may include a Versatile Video Coding (VVC) codec.

In some embodiments, the compact feature extraction module may be configured to project the inter frames into the motion code and the expression attributes. The motion code may include a motion latent code, and the expression attributes may include semantic-level expression attributes.

In some embodiments, the compact feature extraction module may include a motion code extractor to project the inter frames into a motion latent code, and an expression attributes extractor to extract attributes of at least one of face elements.

In some embodiments, the motion latent code may include a multi-dimensional motion latent code entailing head posture and facial expression.

In some embodiments, the expression attributes extractor may extract attributes of at least one of eyes and mouth.

In some embodiments, user-specified emotion attributes may be further provided to the compact feature extraction module for editable-motion interaction.

In some embodiments, the user-specified emotion attributes may include valence and arousal.

In some embodiments, the motion code, the expression attributes and the user-specified emotion attributes may be encoded and transmitted by the feature encoding module through residue prediction, quantization and entropy coding.

According to a second aspect of the invention, there is provided a decoder for face videos encoded by the encoder of the first aspect, which includes a video codec for decoding a coded initial frame of a face video sequence, a feature decoding module for reconstructing compact features of subsequent inter frames, the compact features comprising the motion code and the expression attributes, a disentanglement module for disentangling the motion code into a pose latent code and an expression latent code, an emotion editing module for manipulation of facial latent code at semantic-level based on the expression latent code and the expression attributes to obtain edited expression latent codes, and a frame generation module for producing a video with target emotions based on the decoded initial frame, the edited expression latent codes, and the pose latent code.

In some embodiments, the decoder may further include a window-based smoothing module for applying on the edited expression latent codes for improving temporal consistency in generated face videos.

In some embodiments, the frame generation module may be configured to produce the video with target emotions based on the decoded initial frame, smoothed expression latent codes, and the pose latent code.

In some embodiments, the disentanglement module may include multiple perceptron (MLP) layers which include initial MLP layers serving as shared backbone, followed by two heads composed of additional MLP layers.

In some embodiments, the emotion editing module may be based on conditional continuous normalizing flows (c-CNFs) algorithm to manipulate valence and arousal as desired while preserving the expression attributes.

In some embodiments, the c-CNFs algorithm may include an invertible neural network including forward operating mode and reverse operating mode.

In some embodiments, the c-CNFs algorithm may be designed for learning temporal evolution of the expression latent code extracted from a real-life frame to a standard expression latent code.

In some embodiments, the c-CNFs algorithm may be designed to generate the edited expression latent code of the i^{th} frame (cₑₑ(i)), as provided as below,

$${c}_{e e} ( i ) = {c}_{e e} = {c}_{e 0} + {\int }_{{t}_{0}}^{{t}_{1}} {g}_{θ} ( t , {att}^{*} , {c}_{e} ( t ) ) dt ,$$

where att* encompasses both the user-specified emotion attributes and the expression attributes extracted from the original frame.

According to a third aspect of the invention, there is provided a computer-generated method for encoding face videos, which includes compressing an initial frame of a face video sequence by a video codec, extracting a motion code and expression attributes across subsequent inter frames by a compact feature extraction module, and conducting feature compression with feature-level inter prediction based on the motion code and the expression attributes by a feature encoding module.

According to a fourth aspect of the invention, there is provided a computer-generated method for decoding face videos encoded by the method of the third aspect, which includes decoding a coded initial frame of the face video sequence by the video codec, reconstructing compact features of subsequent inter frames by a feature decoding module, the compact features comprising the motion code and the expression attributes, disentangling the motion code into a pose latent code and an expression latent code by a disentanglement module, manipulating, by an emotion editing module, facial latent code at semantic-level based on the expression latent code and the expression attributes to obtain edited expression latent codes, and producing, by a frame generation module, a video with target emotions based on the decoded initial frame, the edited expression latent codes, and the pose latent code.

In some embodiments, the computer-generated method of the fourth aspect may further include, before producing the video with target emotions, applying a window-based smoothing scheme on the edited expression latent codes for improving temporal consistency in generated face videos.

Other features and aspects of the invention will become apparent by consideration of the detailed description and accompanying drawings. Any feature(s) described herein in relation to one aspect or embodiment may be combined with any other feature(s) described herein in relation to any other aspect or embodiment as appropriate and applicable.

### BRIEF DESCRIPTION OF DRAWINGS

Embodiments of the invention will now be described, by way of example, with reference to the accompanying drawings in which:

FIG. 1A shows a pipeline of an existing codec in terms of emotion editing; FIG. 1B shows a pipeline of a video coding framework according to an embodiment of the invention; FIG. 1C shows comparison between a VVC and the video coding framework according to an embodiment of the invention for ultra-low bitrate face video communication; and FIG. 1D shows editable-emotion interaction across different emotional domains according to an embodiment of the invention.

FIG. 2 shows an emotion-editable generative coding framework according to an embodiment of the invention (hereinafter, “proposed framework”).

FIG. 3 shows a detailed decoder side of the proposed framework.

FIG. 4A shows a detailed architecture of a compact feature extraction module in FIG. 3 according to an embodiment of the invention; FIG. 4B shows a detailed architecture of a disentanglement module in FIG. 3 according to an embodiment of the invention; FIG. 4C shows a detailed architecture of an emotion editing module in FIG. 3 according to an embodiment of the invention; FIG. 4D shows a detailed architecture of a soothing module in FIG. 3 according to an embodiment of the invention; and FIG. 4E shows a detailed architecture of a pose and expression generator in FIG. 3 according to an embodiment of the invention.

FIG. 5A shows rate-distortion performance comparisons with VVC [2], FOMM[29], Face_vid2vid [33], CFTE [3] in terms of perceptual based quality metrics (DISTS); and FIG. 5B shows rate-distortion performance comparisons with VVC [2], FOMM[29], Face_vid2vid [33], CFTE [3] in terms of perceptual based quality metrics (LPIPS).

FIG. 6A and FIG. 6B show the comparisons of visual quality among VVC [2], FOMM[29], Face_vid2vid [33], CFTE [3] and EmoCodec (the proposed framework) at the similar bit-rate. The first row of FIG. 6A corresponds to the original video frames with different emotion categories (i.e. neural, happy, sad and disgust), while the subsequent rows (second and third rows of FIG. 6A and first to third rows of FIG. 6B) depict visual results obtained through various compression methods. In particular, third row of FIG. 6B depicts visual results obtained by the proposed framework. Additionally, the corresponding coding bit-rates and LPIPS values are provided. Note that a lower LPIPS value indicates a higher quality.

FIG. 7 shows visual examples of the proposed framework on the emotion-editable task in terms of different emotional categories (i.e., happy, sad, and disgust) at different edition intensities (i.e., low, moderate and high).

FIG. 8 shows rate-distortion performance comparisons with W2LEmo_OnEnc, EmoStyle_OnEnc, EmoStyle_OnDec in terms of the quality metric of manipulated images (FID).

FIG. 9 shows visual examples of the proposed framework on the ablation study of smoothing.

Before any embodiments of the invention are explained in detail, it is to be understood that the invention is not limited in its application to the details of embodiment and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

Hereinafter, some embodiments of the invention will be described in detail with reference to the drawings.

### EmoCodec: Emotion-Editable Generative Coding

Some embodiments of the invention propose emotion-editable, generative, and compact representation frameworks, aiming to actualize ultra-low bitrate communication of face videos with editable emotion interaction. The EmoCodec aims to project visual face signals into an ultra-compact representation (i.e., a motion latent code and semantic-level facial expression attributes), ensuring significant flexibility and interactivity of coding bitstream with reasonable representation cost. At a decoder side, by disentangling a motion code into two distinct latent codes (i.e., expression and pose), direct manipulation of facial expression code at the semantic level emotion is further enabled. Given the user-specified emotion latent code generated with conditional continuous normalizing flow, the accurate transition in different emotional domains can be achieved, including happiness, sadness and disgust. The window-based smoothing technique further improves temporal consistency in the generated face videos. Extensive experiments demonstrate that the proposed framework can outperform state-of-the-art methods in both the ultra-low bitrate video reconstruction and editable-emotion interaction tasks, which can be expected to shed lights on the future face video communication towards diverse functionalities.

Face video compression and facial expression editing related to some embodiments of the invention will be described first.

### Face Video Coding

In the past decades, a series of video coding standards have been developed, including H.264/Advanced Video Coding (AVC) [35], H.265/High Efficiency Video Coding (HEVC) [30] and H.266/Versatile Video Coding (VVC) [2], significantly facilitating diverse applications including broadcasting, live streaming, and video conferencing. Instead of simply replacing individual modules in these conventional video codecs [23, 41], learning-based image/video compression algorithms [11, 14, 20, 24, 38, 39] are proposed to optimize the entire compression framework in an end-to-end manner. Although the conventional and learning-based video codecs could achieve promising coding efficiency in universal scenes, there is still room for improvement considering the specific application scenarios such as talking face videos.

To realize low-bandwidth face communications, the structure information including semantic parameters or facial edges, has been exploited in Model-Based Coding (MBC) [13, 27]. However, the reconstruction quality of face images in these existing MBC techniques was not satisfactory due to handcrafted analysis-synthesis models. Recently, deep generative models [7, 9, 17] have shown great potentials to remedy the MBC's weaknesses due to the strong inference capabilities. More specifically, based on the First Order Motion Model (FOMM) [29], Konuko et al. [18] proposes a novel face video compression framework to accomplish ultra-low bitrate communication. In addition, Wang et al. [33] develops a free-view talking-head video compression framework by leveraging 3D key-point representation, Furthermore, Chen et al. [3, 4] puts forward a talking face video compression scheme by reasoning the temporal evolution of compact feature representation. Although these generative face video coding frameworks can achieve lifelike face video reconstruction at ultra-low bitrate, they are still difficult to support users' requirements in expression interaction and emotional manipulation, greatly limiting the future metaverse-related applications.

### Facial Expression Editing

The image-level facial expression editing algorithms [6, 15, 40] can be derived from slight adjustment of traditional image-to-image translation methods. However, such category of methodologies may not work well in talking face videos due to coupling expressions with other attributes such as poses. This means that it may affect the head pose when altering the expression of the character in each frame. In order to overcome the limitation of entanglement, Bita et al. [1] introduces the EmoStyle framework, which is designed to separate emotions from other facial characteristics.

It is worth mentioning that all aforementioned methodologies are tailored for static images, which poses challenges in ensuring temporal consistency or inter-frame coherence when applied to video sequences. There are a few approaches developed specifically for the manipulation of facial expressions in videos. More specifically, the Wav2Lip-Emotion method [22] builds upon the lip synchronization framework [28] to edit facial expressions with the assistance of objectives including L1 reconstruction and pre-trained emotion. Sun et al. [31] proposes a two-level expression representation to decompose the motion information into major facial movement and subtle texture changes, allowing the user to control the target emotion in the edited video.

To summarize, the majority of facial expression editing algorithms that depend on high-dimensional representations can meet the demand of users in the application of customized emotion, but they cannot be adapted to ultra-low bitrate face video communication scenarios.

### 1. THE PROPOSED FRAMEWORK

### 1.1 Overview

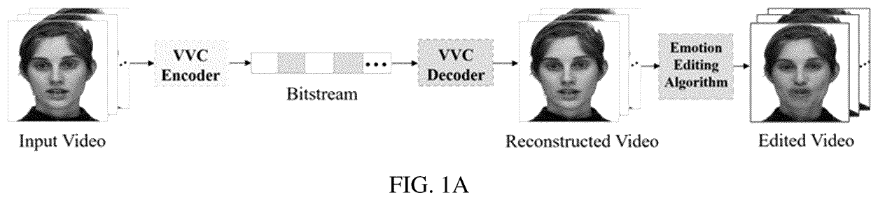

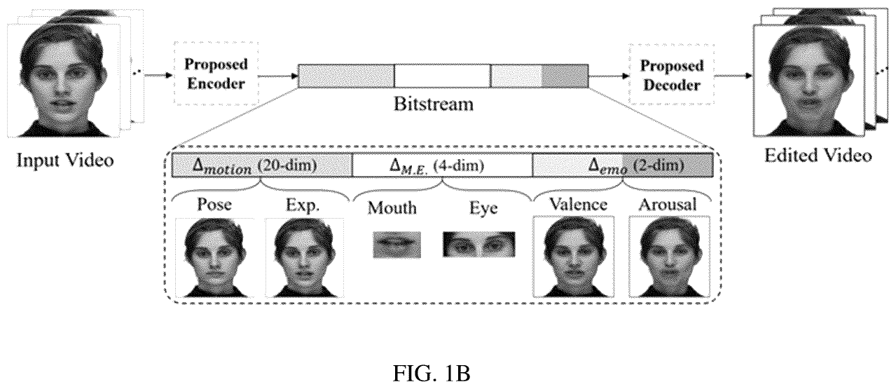

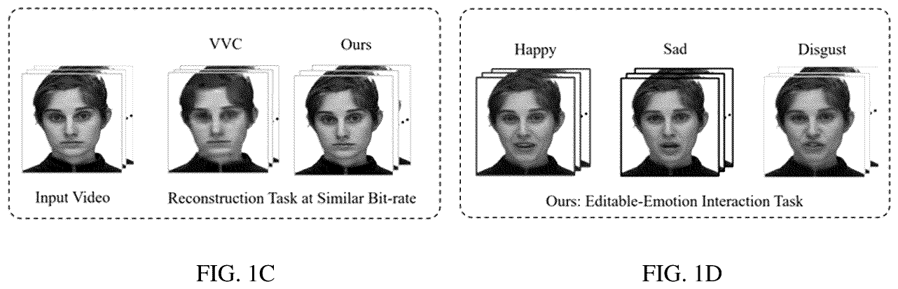

FIG. 1A and FIG. 1B show illustration of the proposed framework in advantageous framework design, and FIG. 1C and FIG. 1D show promising application scenarios. Different from the existing emotion-editable coding algorithms (FIG. 1A) that need additional manipulation processes, the proposed framework (FIG. 1B) can directly achieve emotion editing via ultra-compact and semantically-explicit representations. As such, the proposed framework is able to support ultra-low bitrate face video communication as shown in FIG. 1C and editable-emotion interaction across different emotional domains as shown in FIG. 1D.

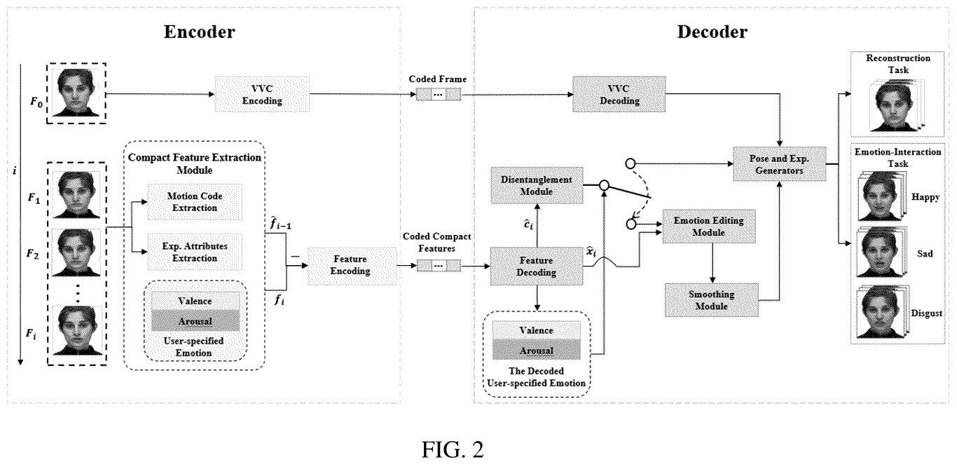

FIG. 2 shows an overview of the proposed framework for ultra-low bandwidth video communication and emotion-editable interaction. The proposed framework based on distinct and compact motion representation includes encoding and decoding processes. Regarding an encoder, the proposed framework primarily consists of three components: (1) a VVC codec responsible for compressing the initial frame of a video sequence (i.e., F₀), (2) a compact feature extraction module for characterizing motion information and expression attributes across inter frames (i.e., Fᵢ(1≤i, i∈Z)), and (3) a feature encoding module (i.e., a context-based arithmetic coding module) for high efficiency feature compression with feature-level inter prediction. Initially, the first frame F₀ is compressed by a VVC encoder to establish the fundamental texture representation and face identity reference for subsequent inter frames Fᵢ. Meanwhile, these successive frames Fᵢ are further mapped to a highly compact representation space via motion code extraction and expression attributes extraction modules. Besides, the user-specified emotion representations (i.e., valence and arousal) are also provided for editable-motion interaction. Subsequently, these extracted and user-defined compact information are efficiently encoded and transmitted through residue prediction, quantization, and entropy coding.

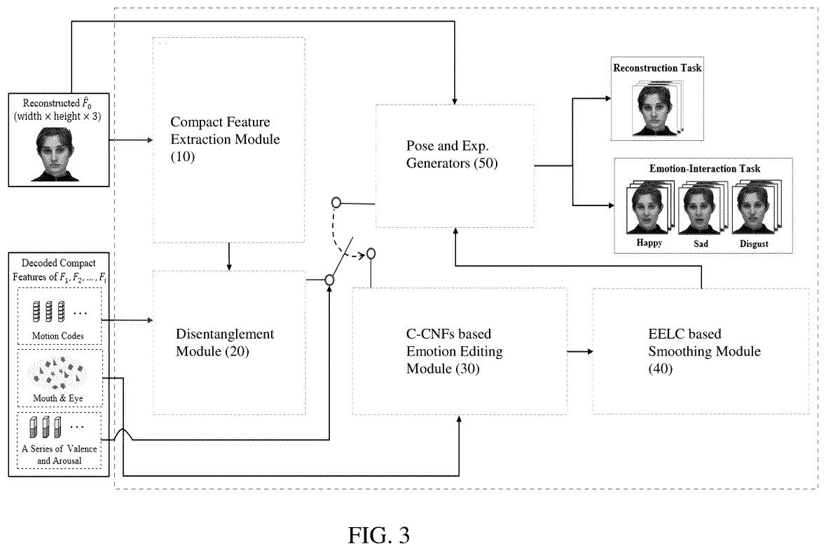

Upon receiving the bitstream, a decoder exhibits flexibility in transitioning between video reconstruction and user-specified emotion editing tasks. Specifically, the reference of texture representation and face identity can be obtained through VVC decoding in coded frame bitstream, while the compact features of subsequent frames can be further reconstructed via feature decoding (i.e., context-based entropy decoding and feature compensation). Importantly, the decoder triggers task selection based on the decoded user-specified emotion commands. For instance, when users provide the commands, an editing emotion module is used to manipulate the disentangled expression code, and a smoothing module is utilized to ensure the temporal consistency of the manipulated codes. Finally, a frame generation module is employed to produce the video with target emotions by the decoded reference frames, the smoothed expression codes, and the original pose codes. As depicted in FIG. 3, both video reconstruction and emotion editing tasks can be achieved by the proposed decoder without any additional manipulation algorithms.

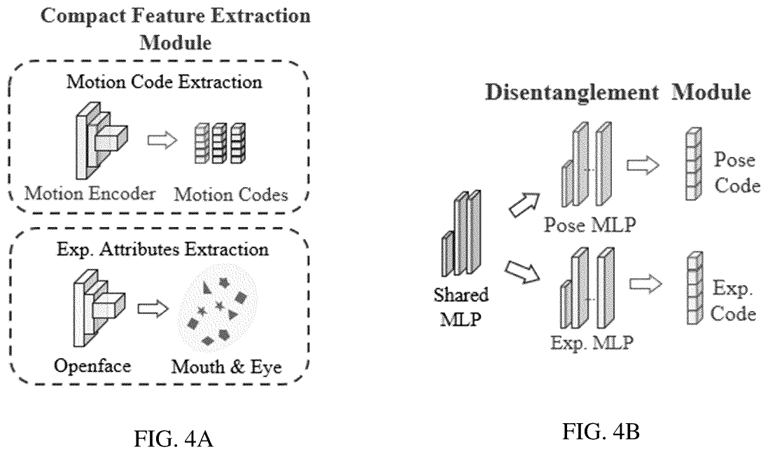

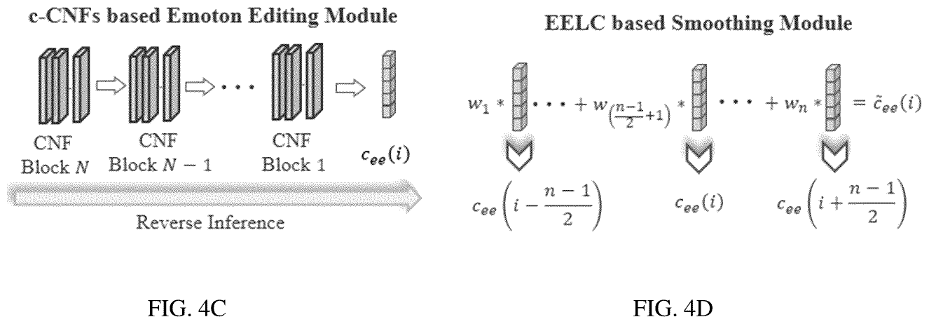

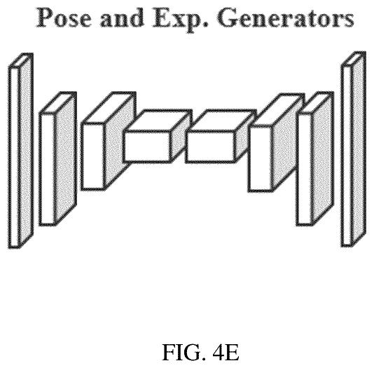

FIG. 3 shows a detailed decoder-side architecture regarding how to flexibly employ semantic-level representations to enable video reconstruction and emotion editing tasks. The decoder according to some embodiments may include a compact feature extraction module (10), a disentanglement module (20), an emotion editing module (i.e., c-CNFs based emotion editing module, 30), an EELC based smoothing module (40) and pose and expression generators (50). FIG. 4A shows a detailed architecture of the compact feature extraction module (10) in FIG. 3 according to an embodiment of the invention, FIG. 4B shows a detailed architecture of the disentanglement module (20) in FIG. 3 according to an embodiment of the invention, FIG. 4C shows a detailed architecture of the emotion editing module (30) in FIG. 3 according to an embodiment of the invention, FIG. 4D shows a detailed architecture of the soothing module (40) in FIG. 3 according to an embodiment of the invention, and FIG. 4E shows a detailed architecture of the pose and expression generators (50) in FIG. 3 according to an embodiment of the invention.

### 1.2 Compact Feature Extraction Module

In this subsection, some embodiments of the invention aim to acquire ultra-compact representations related to facial motion and semantic-level expression attributes, which can serve as the foundation for both ultra-low bitrate video communication and emotion manipulation tasks.

Regarding compact representations in facial motion code, a motion code extractor (i.e., Extractor) [26] is employed to project the high-dimensional face signal Fᵢ into a latent space as follows,

$$c ( i ) = Extractor ( {F}_{i} ) , \qquad ( 1 )$$

where c (i) is a 20-dimensional motion latent code entailing enriched head posture and facial expression.

As for the semantic-level mouth attributes, the pre-trained OpenFace 2.0 model [32] is introduced to extract landmarks of the upper and lower lips. To compress the acquired landmarks and enhance the generalization of mouth representation [16], the mouth aspect ratio (i.e., MAR) is further computed as an indicator in mouth openness. Moreover, the OpenFace 2.0 model is also utilized to obtain compact and accurate eye-related attributes, including gaze angle and blink intensity. Finally, the process of deriving compact attributes of eyes and mouth can be described as follows,

$${x}_{mouth} ( i ) , {x}_{eye} ( i ) = Openface ( {F}_{i} ) , \qquad ( 2 )$$

$${\tilde{x}}_{mouth} ( i ) = MAR ( {x}_{mouth} ( i ) ) , \qquad ( 3 )$$

where the dimension of \tilde{x}ₘₒᵤₜₕ(i) is 1, and the dimension of x_{eye} (i) is 3, respectively.

It is worth mentioning that the acquisition method of emotion valence and emotion arousal depends on the stage at which the model is. During the training phase, the emotion recognition network, namely EMOCA [8], can be employed to derive two emotion attributes (i.e., valence vᵢ and arousal aᵢ) from training frames. The process can be formulated as,

$${v}_{i} , {a}_{i} = EMOCA ( {F}_{i} ) . \qquad ( 4 )$$

During the testing phase, users can provide self-defined emotion attributes according to their emotional requirements. In a word, the difference in the acquisition methods of emotional attributes across different stages are determined by the algorithm employed within the proposed emotion editing module. The specific principle will be presented in subsection 1.4.

To conclude, the proposed feature representation scheme in facial motion (20-dim), semantic-level expression attributes (4-dim) and user-specified emotion information (2-dim) is highly compact and disentangled for describing the important structure and motion information of face signal, greatly facilitating the high-quality face video reconstruction and diverse-functionalities emotional interaction within ultra-low bitrate scenarios.

### 1.3 Disentanglement Module

Generally speaking, facial motion encompasses head pose motion and expression motion. However, due to the highly coupled nature of these two motions, decoupling becomes a prerequisite for the emotion editing task. This means that the disentanglement in facial expressions from facial motions can enable direct editing from the source emotion to the target emotion.

To achieve this, multiple perceptron (MLP) layers [26] are employed to disentangle the latent space of the encoder into two orthogonal subspaces: the pose motion space and the expression motion space. The structure of the disentanglement module involves the initial MLP layers serving as the shared backbone, followed by two heads composed of additional MLP layers. The process of disentangling can be denoted as follows,

$${c}_{p} ( i ) , ( i ) = MLP ( c ( i ) ) . \qquad ( 5 )$$

where cₚ (i) refers to the pose latent code, and cₑ (i) denotes the expression latent code.
1.4 c-CNFs Based Emotion Editing Module

After separating the expression latent code and defining semantic-level expression attributes, the conditional continuous normalizing flows (c-CNFs) algorithm [12] can be utilized to manipulate valence and arousal as desired while preserving other expression attributes including mouth and eye. This capability is attributed to the inherent characteristic of c-CNFs, i.e., this algorithm is an invertible neural network including forward operating mode and reverse operating mode.

Generally speaking, c-CNFs characterize the temporal evolution of data transformations, which can be expressed as an ordinary differential equation (ODE) [12],

$$\frac{{dc}_{e} ( i , t )}{dt} = {g}_{θ} ( t , att , {c}_{e} ( i , t ) ) , \qquad ( 6 )$$

where att denotes the expression attributes, and cₑ (i, t) is the expression latent code of the i^{th} frame at time t. Next, cₑ (i, t) will be simplified to cₑ (t).

In the forward mode, which corresponds to the training stage, the input is the expression latent code cₑ [symbol] cₑ (t₀) extracted from a real-life frame and the corresponding expression attribute representation att, as well as the output is the standard expression latent Code cₑ₀ [symbol] cₑ (t₁)˜N(0,1). Because cₑ evolves to cₑ₀ over time with the dynamics parameterized by g_{θ}[5, 12], cₑ₀ can be computed by integrating g_{θ} across the time interval from t₀ to t₁,

$${c}_{e 0} = {c}_{e} + {\int }_{{t}_{0}}^{{t}_{1}} {g}_{θ} ( t , att , {c}_{e} ( t ) ) dt , \qquad ( 7 )$$

To model the relationship between the unknown and complex distribution and the standard normal distribution, c-CNFs are trained by minimizing the negative log-likelihood loss. The loss function [12] can be expressed as follows,

$$\begin{matrix}L ( θ ; {c}_{e 0} , att ) = - log {p}_{{c}_{e 0} \vert att} ( {c}_{e 0} ; att , θ ) \\ = - log {p}_{{c}_{e}} ( {c}_{e} ) + {\int }_{{t}_{0}}^{{t}_{1}} Tr ( \frac{\partial {g}_{θ}}{\partial {c}_{e} ( t )} ) dt ,\end{matrix} \qquad ( 8 )$$

During the reverse mode, which pertains to the testing stage, users have the capability to input a customized representation of expression attributes att* along with a randomly sampled normal latent code into the pre-trained c-CNFs, thereby enabling the generation of the expression latent code corresponding to the target emotion. Thus, the edited expression latent code of the i^{th} frame is computed as follows [12],

$${c}_{ee} ( i ) = {c}_{ee} = {c}_{e 0} + {\int }_{{t}_{0}}^{{t}_{1}} {g}_{θ} ( t , {att}^{*} , {c}_{e} ( t ) ) dt . \qquad ( 9 )$$

where att* encompasses both the user-specified emotion attributes and the eye and mouth attributes extracted from the original frame.

To conclude, c-CNFs excel at learning the evolutionary trajectory from the expression latent code derived from real-world data to a standard normal expression code. Moreover, due to the intrinsic reversibility of c-CNFs, during the testing phase, the manipulated expression latent codes will conform to the distribution of real-world expression latent codes.

### 1.5 EELC Based Smoothing Module

In the absence of smoothing, the manipulated facial expressions may exhibit temporal discontinuities, such as jitters, due to their frame-by-frame generation process. To deal with this issue, some embodiments of the invention implement a Hanning window [21] smoothing technique based on edited emotion latent codes (i.e., EELC), as shown in FIG. 4D. In particular, the coefficient of this window can be computed as given in the following equation,

$$w ( n ) = 0.5 * ( 1 - cos ( 2 π \frac{n}{m} ) ) , \qquad ( 10 )$$

where m is the window size, and n refers to the number of the window. To be more specific, some embodiments of the invention can assign different weights to the manipulated latent codes of the preceding and succeeding frames (i.e., cₑ (i−1) and cₑ (i+1)) by changing the numerical value n, and then derive the smoothed latent code of the current frame by computing the weighted sum of neighboring latent codes. The formula of the smoothed expression latent code is as follows,

$${\tilde{c}}_{ee} ( i ) = {w}_{1} * {c}_{ee} ( i - \frac{n - 1}{2} ) + … + {w}_{( \frac{n - 1}{2} + 1 )} * {c}_{ee} ( i ) + … + {w}_{n} * {c}_{ee} ( i + \frac{n - 1}{2} ) . \qquad ( 11 )$$

where cₑₑ (i) is the edited expression latent code for the current frame,

$${c}_{ee} ( i - \frac{n - 1}{2} ) and {c}_{ee} ( i + \frac{n - 1}{2} )$$

are the neighbouring expression codes, and \tilde{c}ₑₑ(i) denotes the smoothed code.

The efficacy of the straightforward smoothing procedure stems from several factors: (1) the separation of the expression latent code from the pose latent code and the decomposition of expression from a motion perspective into four attributes, and (2) the closeness of latent codes in the expression space derived from successive frames. Obviously, this kind of proximity facilitates their effective smoothing through a straightforward weighted process.

### 1.6 Other Technology Details

During the implementation process, some existing coding tools are also utilized to contribute to the proposed framework. On the one hand, the standard, known as VVC intra, is employed for the compression and decompression of reference frames, enhancing the realism of the generated results for successive frames. On the other hand, a context-based entropy coding scheme is utilized to efficiently compress the compact features of the subsequent talking face frames. Specifically, the concept of inter-frame prediction is used to eliminate the redundancy between these features. This process can be formalized as:

$${Res}_{i} = {Δ}_{com} ( i ) - {\hat{Δ}}_{com} ( i - 1 ) , i \geq 2 ,$$

where \hat{Δ}_{com}(i−1) is the reconstructed compact face features for the (i−1)^{th} frame, and Δ_{com}(i) denotes the original facial features for the i^{th} frame. Following this, the inter-predicted residuals Resᵢ undergo quantization and then further transformed into binary codes using, for example, the zero-order exponential Golomb algorithm [45]. Finally, the context-based arithmetic coding model [42] is employed to generate the final bitstream. Conversely, the facial features are decoded in the order of entropy decoding, inverse quantization, and compensation.

### 2 EXPERIMENTAL RESULTS

### 2.1 Implementation Details

The dataset used in this disclosure comprises the video data sourced from the Ryerson Audio-Visual Database of Emotional Speech and Song (RAVDESS) [19], which is subsequently resized to dimensions of 256×256. Specifically, the training data used in this disclosure is from actor ID 1 to actor ID 21. The testing data used in this disclosure is derived from the remaining, comprising 30 testing sequences containing 125 frames for the video reconstruction task and 10 testing sequences containing 108 frames for the emotion editing task.

Experimental setup consists of the operating system of Ubuntu 18.04, the deep learning framework of PyTorch 1.12.1, an Intel® Xeon® Gold 6130 CPU, and an NVIDIA Tesla V100-32 GB GPU. As for the training of the entire model, there are two phases: (1) The visual data spanning from actor ID 1 to actor ID 10 is utilized to fine-tune the motion code extractor, the disentanglement module, and the pose and expression generators. (2) EMOCA [8] is employed to recognize the emotion category across all frames from actor ID 11 to actor ID 21, thereby establishing a foundation for the selection of the expression latent codes used for training the c-CNFs based emotion editing module.

### 2.2 Baseline Algorithms

In order to validate the efficacy of the proposed framework, a comparative analysis is conducted on the proposed framework and four baseline methods. These baseline methods include the latest hybrid video coding standard VVC (VTM23.0 [2]) and three generative face video compression schemes, namely FOMM [29], Face_vid2vid [33], and CFTE [3]. Meanwhile, two learning-based visual quality metrics are employed for assessing the reconstruction quality of the generated outputs: Learned Perceptual Image Patch Similarity (LPIPS) [37], and Deep Image Structure and Texture Similarity (DISTS) [10]. In the context of these two quality metrics, a lower score denotes a higher perceived image quality. In addition, the rate-distortion curve (RD-curve), which is a widely-used evaluation method in video compression tasks, is utilized to evaluate the compression performance.

### 2.3 Reconstruction Task

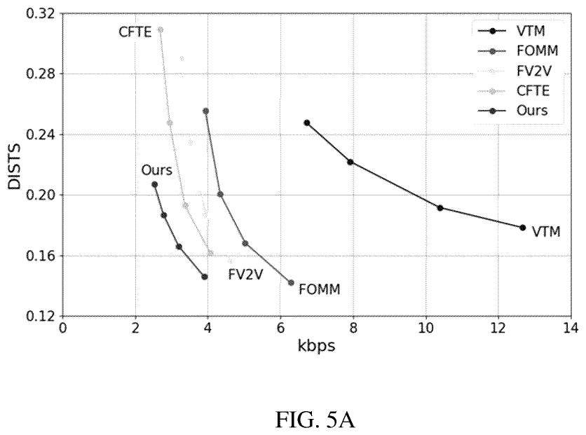

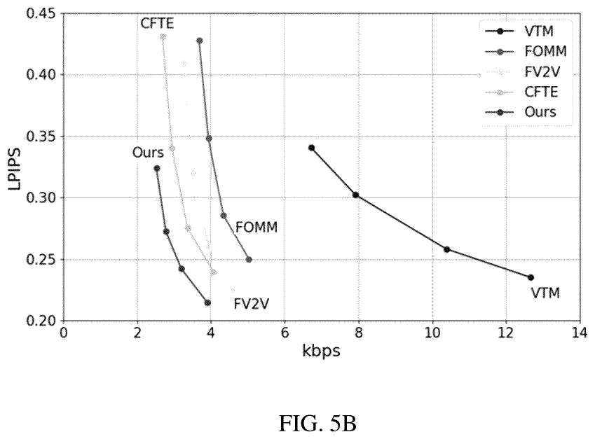

2.3.1 Objective Quality. FIG. 5A and FIG. 5B show that the proposed framework outperforms VVC and three generative face video coding schemes in terms of DISTS and LPIPS metrics. More specifically, it is observed significant bitrate savings compared to the latest hybrid video coding standard VVC (VTM23.0). Moreover, the proposed framework still demonstrates notable performance advantages when compared to FOMM, CFTE, and Face_vid2vid. Particularly noteworthy is the performance enhancement achieved in both DISTS and LPIPS metrics compared to the generative compression method (CFTE).

Table 1 illustrates the significant bitrate savings achieved by the proposed framework in terms of DISTS and LPIPS metrics. Specifically, the proposed framework exhibits substantial bitrate reductions compared to the latest hybrid video codec VVC, with savings of 73.22% and 68.70% in DISTS and LPIPS, respectively. Furthermore, the proposed framework outperforms the generative face video compression algorithms.

TABLE 1
Average bit-rate savings of 30 talking face sequences
in terms of rate-DISTS and rate-LPIPS.

Quality Measure

| Anchors | rate-DISTS | rate-LPIPS |
|---|---|---|
| VVC [2] | −73.22% | −68.70% |
| FOMM [29] | −38.92% | −37.97% |
| Face_vid2vid [33] | −28.78% | −26.00% |
| CFTE [3] | −19.67% | −17.74% |

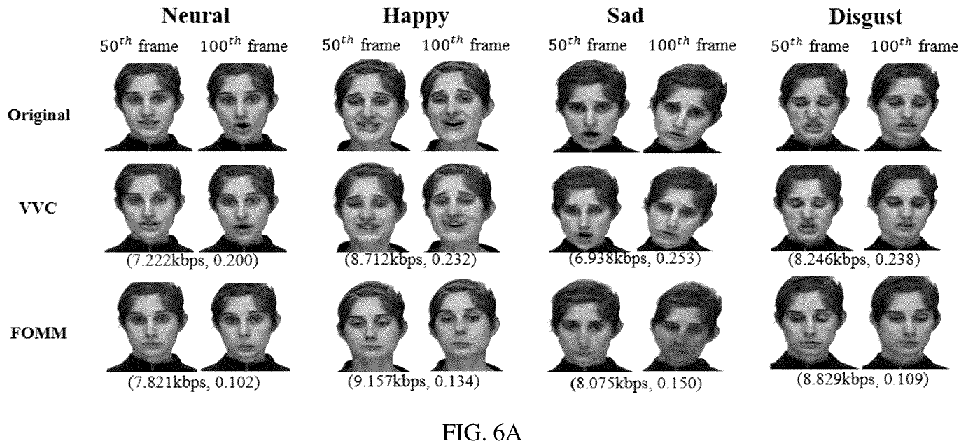

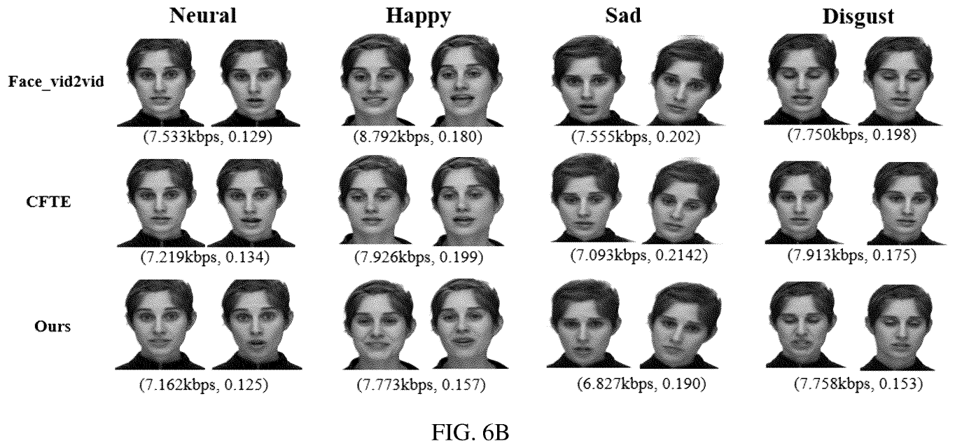

2.3.2 Subjective Quality. FIG. 6A and FIG. 6B depict the visual quality of different compression schemes on the 50th and 100th frames of four talking facial sequences at similar bitrates. Observations reveal that, at comparable bitrates, the talking face videos reconstructed from the VVC standard exhibit severe blocking artifacts, while the proposed framework achieves clear facial features reconstruction.

In comparison to the generative face video compression schemes, including FOMM, Face_vid2vid and CFTE, both the proposed framework and these three methods achieve accurate pose motion reconstruction, with disparities primarily observed in the accurate reconstruction of expressions. Specifically, when the original video contains rich facial expressions, FOMM struggles to reconstruct corresponding expressions, resulting in significant facial distortions. This may be attributed to FOMM's lack of learning texture-level expression features of inter frames, that is, FOMM mainly focuses on the modeling of keypoints that support complex motion. Additionally, Face_vid2vid and CFTE also fall short in accurately expressing emotional categories. Furthermore, FOMM, Face_vid2vid, and CFTE exhibit deficiencies in aligning eye gaze and openness with the original frames. Consequently, the proposed framework not only preserves facial expression details across various emotional categories but also reconstructs high-quality facial images consistent with the eye gaze and openness of the original frames at similar bitrate.

A subjective test is conducted to compare the visual quality between the proposed framework and the VVC standard. Specifically, 10 participants are asked to select the video with better visual quality from a pair of reconstructed videos that consumed a similar amount of coding bits. Each pair consists of one video from the VVC standard and one from the proposed framework. It is worth mentioning that video pairs are randomly presented to avoid experimental bias. It is found that that each participant consistently select the video reconstructed by the proposed framework as their preferred choice across all ten pairs of videos.

### 2.4 Editable-Emotion Interaction Task

This subsection presents subjective experiments focusing on the precise manipulation of both emotion categories and intensity. Additionally, subjective and objective evaluations of emotion for edited videos are provided. The rate-distortion performance and the ablation study of smoothing for this task are also provided.

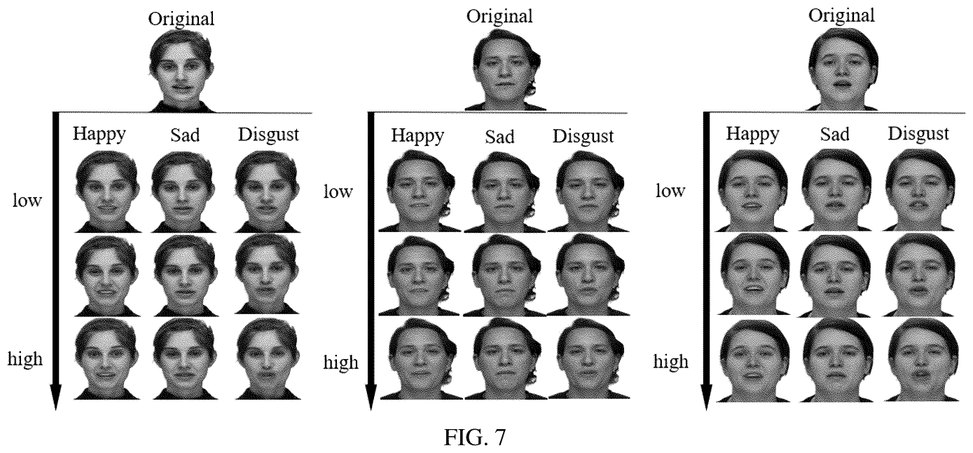

2.4.1 Emotion Control. FIG. 7 illustrates the precise manipulation of emotion categories, such as happy, sad, and disgust, across diverse identities by the proposed framework. In addition, the proposed framework excels in continuously adjusting the intensity levels of emotions from low to high and vice versa. Furthermore, it is observed that the eye gaze direction and mouth openness in the edited frames closely resemble those in the original frames. Thus, owing to the definition of semantic-level expressive attributes within the bitstream, the proposed framework can accurately manipulate emotion categories and intensities while preserving the original mouth and eye features.

2.4.2 Emotion Evaluation. To verify whether the edited videos exhibit the target emotion, objective and subjective evaluations are conducted.

In the objective experiment, we calculate the mean number of frames that are recognized as the target emotion and the corresponding percentage across 27 edited videos, as shown in Table 2. Specifically, there are three original videos, and each of them is manipulated by combining any one of the three emotion categories with any one of the three emotion intensity levels. As a result, each emotion category corresponds to nine edited videos. Subsequently, EMOCA [8] is utilized to identify the emotion categories of all frames in each edited video. Then, the number of frames recognized as the target emotion in each video is counted. For instance, when the target emotion is “Happy,” we tally the number of “Happy” frames in the nine videos manipulated by “Happy”. Then, we compute the average count of “Happy” frames across these nine videos, and the corresponding percentage of “Happy” frames. It is observed that the percentages of happy, sad and disgust frames are 54.63%, 78.70%, and 87.96%, respectively.

TABLE 2
Objective evaluation for edited videos with different
target emotions. The mean number of frames that are
recognized as the target emotion and the corresponding
percentage across 27 edited videos are calculated.

Target Emotion

| Score | Happy | Sad | Disgust |
|---|---|---|---|
| Mean Frame Number | 59 | 85 | 95 |
| Percent | 54.63% | 78.70% | 87.96% |

In addition, a subjective evaluation of the accuracy in recognizing the edited videos as the target emotion is conducted. Specifically, 10 edited videos that featuring three target emotions and the high emotional intensity are prepared, and a relatively even distribution in terms of emotion category is ensured. Subsequently, 10 participants are asked to choose an option from happiness, sadness, and disgust for each video. To minimize experimental bias, the edited videos are presented randomly to the participants. Finally, the accuracy of recognizing the generated videos as the target emotion is calculated using both the predicted labels and the true labels. The results are shown in Table 3.

TABLE 3
Subjective evaluation of the accuracy in recognizing
the edited videos as the target emotion.

| | Target Emotion | | |
|---|---|---|---|
| Score | Happy | Sad | Disgust |
| Accuracy | 80.00% | 87.78% | 84.44% |

| | |
|---|---|
| Overall Accuracy | 83.67% |

### 2.4.3 the Rate-Distortion Performance

To ascertain the effectiveness of the proposed framework in terms of rate-distortion performance, a comparative evaluation against three baseline methods is conducted. Four aspects are described: (1) the design of the baseline methods, (2) the preparation of testing sequences, (3) the selection of quality metrics, and (4) the experimental results.

These baseline methods include W2LEmo_OnEnc [2, 22], EmoStyle_OnEnc [1, 2], and EmoStyle_OnDec [1, 2]. Specifically, W2LEmo_OnEnc refers to the utilization of the editing emotion algorithm, namely W2LEmo [22], by the user at the encoding stage to fulfill their emotional requirements, followed by encoding and decoding the manipulated frames using the latest hybrid video coding standard VVC [2]. Similarly, EmoStyle_OnEnc denotes the utilization of EmoStyle [1] at the encoding stage. However, EmoStyle_OnDec implies the manipulation of the decoded face talking videos using EmoStyle [1], according to the user's emotional commands. Note that W2LEmo_OnDec is not listed as a baseline method for two reasons: firstly, W2LEmo takes both the original video and the corresponding audio as input; secondly, the data source for VVC is video.

10 testing sequences with neutral expressions, each sequence containing 108 frames, are prepared for the emotion editing task. Considering the limitation of W2LEmo, which can only generate videos with happy or sad expressions at a single intensity, both the EmoCodec and EmoStyle also focus on the manipulation of these two target emotions (i.e., happy and sad), as well as the manipulation of high emotion intensity.

Regarding the selection of the quality metric for manipulated images, Frechet Inception Distance (FID) [44] is used to assess the score between the manipulated video and the groundtruth video with the target emotion. This choice was motivated by the fact that FID calculates the distance between distributions of real images and generated images in the embedding space [43]. In the FID metric, a lower score indicates higher quality of manipulated images.

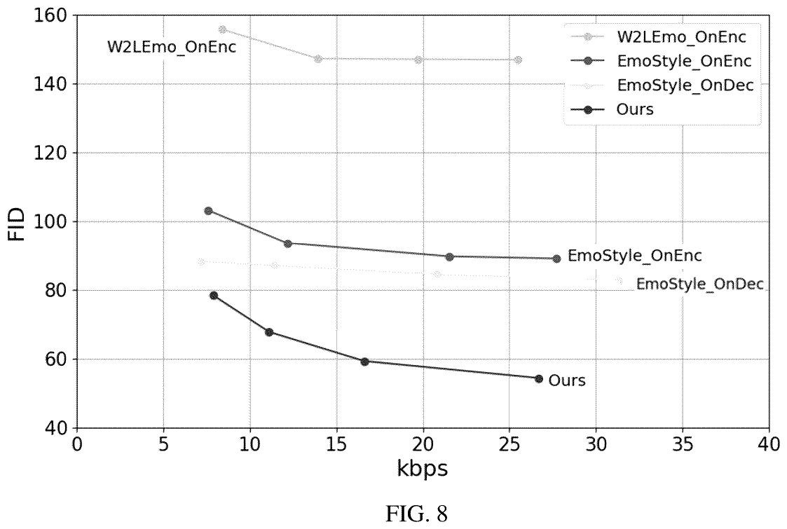

FIG. 8 illustrates the superior performance of the proposed framework compared to W2LEmo_OnEnc [2, 22], EmoStyle_OnEnc [1, 2] and EmoStyle_OnDec [1, 2] in terms of the FID metric. Specifically, across different bitrates, the FID scores of the proposed framework are consistently lower than those of the other three baseline methods, indicating the highest quality of manipulated images achieved by the proposed framework.

### 2.4.4 Qualitative Ablation Study of Smoothing

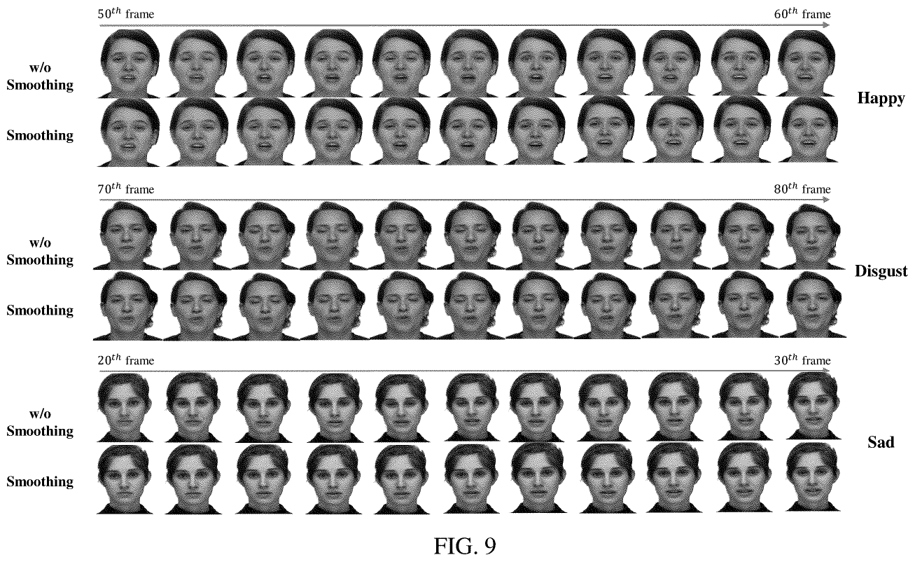

FIG. 9 illustrates the qualitative ablation study of smoothing conducted on the proposed framework. It can be observed that when the proposed framework utilizes the smoothing technique, the motion between adjacent frames becomes significantly consistent, particularly evident in the degree of mouth openness and the degree of eye blink. This temporal consistency is attributed to the utilization of Edited Emotion Latent Codes (EELC) based Smoothing Module, which ensures that adjacent manipulated expression latent codes are closer in the facial expression space. However, in the absence of smoothing, significant jitter is observed between adjacent frames. For example, on the ‘w/o Smoothing’ sub-row of the “Happy” row, the eye-opening intensity is notably high in the 50^{th} frame, followed by sudden eye closure in the 51^{st} frame.

### 3 CONCLUSION

In this disclosure, some embodiments of the invention propose the EmoCodec to meet the exponential increase in the demand for ultra-low bitrate communication of facial videos with emotion-editable interactions. Key idea is to project visual face signals into a compact representation containing the motion code and the semantic-level expression attributes. This approach enjoys two advantages at the decoding end: (1) decoupling the motion code into an expression code and a pose code facilitates direct manipulation of facial expression code; (2) semantic-level expression attributes enable user-specified emotion interactions. Extensive experiments demonstrate that the EmoCodec achieves significant bitrate savings compared to the existing VVC and generative face video compression methods in terms of DISTS and LPIPS, and it also offers accurate transitions across diverse emotion domains and intensities.

### Example Features of Some Embodiments

(1) The editable-emotion generative video coding framework (EmoCodec) is proposed to enjoy the desired advantages in ultra-compact feature representation and interpretable coding bitstream. As such, the EmoCodec can support both ultra-low bitrate communication and editable-emotion interaction.

(2) A compact feature extraction module is designed to acquire ultra-compact representations related to facial motion and semantic-level expression attributes, which can serve as the foundation for both ultra-low bitrate video communication and emotion manipulation tasks. To conclude, the proposed feature representation includes facial motion (20-dim), semantic-level expression attributes (4-dim) and user-specified emotion information (2-dim).

(3) Multiple perceptron (MLP) layers is employed to disentangle the latent space of the encoder into two orthogonal subspaces: the pose motion space and the expression motion space. The structure of the disentanglement module involves the initial MLP layers serving as the shared backbone, followed by two heads composed of additional MLP layers.

(4) The conditional continuous normalizing flows (c-CNFs) based emotion editing module algorithm is proposed to manipulate valence and arousal as desired while preserving other expression attributes including mouth and eye.

(5) A Hanning window smoothing technique based on edited emotion latent codes (i.e., EELC) is implemented to deal with this issue, that is the temporal discontinuities of the manipulated facial expressions, such as jitters.

### Example Functions and Applications of Some Embodiments

Example functions of some embodiments of the invention are both the ultra-low bitrate video reconstruction and editable-emotion interaction. And example applications of the invention is the future face video communication.

### Example Advantages of Some Embodiments

Some embodiments of the invention can train and test on diverse emotional talking face video datasets, such as the Ryerson Audio-Visual Database of Emotional Speech and Song dataset (RAVDESS) [19], and the Large-scale Audio-visual Dataset for Emotional Talking-face Generation dataset (MEAD) [46].

Some embodiments of the invention can achieve the reconstruction and emotion editing tasks for talking face videos by solely transmitting a 26-dimensional feature representation. This 26-dimensional feature representation comprises facial motion (20-dim), semantic-level expression attributes (4-dim), and user-specified emotion information (2-dim).

In addition to the emotion editing task, some embodiments of the invention can be extended to manipulate various aspects such as head pose rotation, head-to-camera distance, hair style, clothing style, and so on. During the training stage, two types of information can be initially extracted: (i) Various attributes of individuals in the video, such as head pose attributes, head-to-camera distance attributes, hair attributes, clothing attributes, and other types of attributes, are extracted using appropriate technologies, such as OpenFace2. (ii) Latent codes for manipulation, such as expression latent codes, pose latent codes, identity codes, texture latent codes, and other types of latent codes, are extracted by a disentanglement module. Subsequently, the extracted attributes and latent codes are employed to train the corresponding editing modules. For instance, the head pose rotation and head-to-camera distance attributes, along with the pose latent codes, are jointly trained in the pose editing based on c-Conditional Neural Fields (c-CNFs) module. During the testing stage, the user-specified attributes can be utilized to generate the desired latent codes. These manipulated codes are then used as inputs to the generators to generate the desired videos.

To further enhance the generalization capability of the proposed model (i.e., handling out-of-distribution data) and improve the visual quality of generated videos, some embodiments of the invention can employ the conditional latent diffusion transformer [49, 50] to replace both the c-CNFs based emotional/pose editing module and the generators (i.e., Generative Adversarial Networks).

The proposed framework can support both ultra-low bitrate communication and editable-emotion interaction.

It will be appreciated by a person skilled in the art that variations and/or modifications may be made to the described and/or illustrated embodiments of the invention to provide other embodiments of the invention. The described/or illustrated embodiments of the invention should therefore be considered in all respects as illustrative, not restrictive. Example optional features of some embodiments of the invention are provided in the summary and the description. Some embodiments of the invention may include one or more of these optional features. Some embodiments of the invention may lack one or more of these optional features.

### REFERENCES

All referenced literatures throughout this disclosure are incorporated herein by reference in their entirety, which include the following references:
[1] Bita Azari and Angelica Lim. 2024. EmoStyle: One-Shot Facial Expression Editing Using Continuous Emotion Parameters. In Proceedings of the IEEE/CVF Winter Conference on Applications of Computer Vision. 6385-6394.
[2] Benjamin Bross, Ye-Kui Wang, Yan Ye, Shan Liu, Jianle Chen, Gary J Sullivan, and Jens-Rainer Ohm. 2021. Overview of the versatile video coding (VVC) standard and its applications. IEEE Transactions on Circuits and Systems for Video Technology 31, 10 (2021), 3736-3764.
[3] Bolin Chen, Zhao Wang, Binzhe Li, Rongqun Lin, Shiqi Wang, and Yan Ye. 2022. Beyond keypoint coding: Temporal evolution inference with compact feature representation for talking face video compression. In 2022 Data Compression Conference (DCC). IEEE, 13-22.
[4] Bolin Chen, Zhao Wang, Binzhe Li, Shiqi Wang, and Yan Ye. 2023. Compact Temporal Trajectory Representation for Talking Face Video Compression. IEEE Transactions on Circuits and Systems for Video Technology 33, 11 (2023), 7009-7023. https://doi.org/10.1109/TCSVT.2023.3271130
[5] Ricky T Q Chen, Yulia Rubanova, Jesse Bettencourt, and David K Duvenaud. 2018. Neural ordinary differential equations. Advances in neural information processing systems 31 (2018).
[6] Yunjey Choi, Minje Choi, Munyoung Kim, Jung-Woo Ha, Sunghun Kim, and Jaegul Choo. 2018. Stargan: Unified generative adversarial networks for multidomain image-to-image translation. In Proceedings of the IEEE conference on computer vision and pattern recognition. 8789-8797.
[7] Antonia Creswell, Tom White, Vincent Dumoulin, Kai Arulkumaran, Biswa Sengupta, and Anil A Bharath. 2018. Generative adversarial networks: An overview. IEEE signal processing magazine 35, 1 (2018), 53-65.
[8] Radek Daněček, Michael J Black, and Timo Bolkart. 2022. Emoca: Emotion driven monocular face capture and animation. In Proceedings of the IEEE/CVF Conference on Computer Vision and Pattern Recognition. 20311-20322.
[9] Prafulla Dhariwal and Alexander Nichol. 2021. Diffusion models beat gans on image synthesis. Advances in neural information processing systems 34 (2021), 8780-8794.
[10] Keyan Ding, Kede Ma, Shiqi Wang, and Eero P Simoncelli. 2020. Image quality assessment: Unifying structure and texture similarity. IEEE transactions on pattern analysis and machine intelligence 44, 5 (2020), 2567-2581.
[11] Wenhong Duan, Kai Lin, Chuanmin Jia, Xinfeng Zhang, Siwei Ma, and Wen Gao. 2022. End-to-end image compression via attention-guided informationpreserving module. In 2022 IEEE International Conference on Multimedia and Expo (ICME). IEEE, 1-6.
[12] Will Grathwohl, Ricky T Q Chen, Jesse Bettencourt, Ilya Sutskever, and David Duvenaud. 2018. Ffjord: Free-form continuous dynamics for scalable reversible generative models. arXiv preprint arXiv:1810.01367 (2018).
[13] Michael Hotter. 1994. Optimization and efficiency of an object-oriented analysissynthesis coder. IEEE Transactions on Circuits and Systems for video technology 4, 2 (1994), 181-194.
[14] Zhihao Hu, Guo Lu, and Dong Xu. 2021. FVC: A new framework towards deep video compression in feature space. In Proceedings of the IEEE/CVF Conference on Computer Vision and Pattern Recognition. 1502-1511.
[15] Phillip Isola, Jun-Yan Zhu, Tinghui Zhou, and Alexei A Efros. 2017. Image-toimage translation with conditional adversarial networks. In Proceedings of the IEEE conference on computer vision and pattern recognition. 1125-1134.
[16] Zhuoni Jie, Marwa Mahmoud, Quentin Stafford-Fraser, Peter Robinson, Eduardo Dias, and Lee Skrypchuk. 2018. Analysis of yawning behaviour in spontaneous expressions of drowsy drivers. In 2018 13th IEEE International Conference on Automatic Face & Gesture Recognition (FG 2018). IEEE, 571-576.
[17] Diederik P Kingma and Max Welling. 2013. Auto-encoding variational bayes. arXiv preprint arXiv:1312.6114 (2013).
[18] Goluck Konuko, Giuseppe Valenzise, and Stéphane Lathuiliere. 2021. Ultra-low bitrate video conferencing using deep image animation. In ICASSP 2021-2021 IEEE International Conference on Acoustics, Speech and Signal Processing (ICASSP). IEEE, 4210-4214.
[19] Steven R Livingstone and Frank A Russo. 2018. The Ryerson Audio-Visual Database of Emotional Speech and Song (RAVDESS): A dynamic, multimodal set of facial and vocal expressions in North American English. PloS one 13, 5 (2018), e0196391.
[20] Guo Lu, Wanli Ouyang, Dong Xu, Xiaoyun Zhang, Chunlei Cai, and Zhiyong Gao. 2019. Dvc: An end-to-end deep video compression framework. In Proceedings of the IEEE/CVF Conference on Computer Vision and Pattern Recognition. 11006-11015.
[21] Luming Ma and Zhigang Deng. 2019. Real-Time Facial Expression Transformation for Monocular RGB Video. In Computer Graphics Forum, Vol. 38. Wiley Online Library, 470-481.
[22] Ian Magnusson, Aruna Sankaranarayanan, and Andrew Lippman. 2021. Invertable frowns: Video-to-video facial emotion translation. In Proceedings of the 1st Workshop on Synthetic Multimedia-Audiovisual Deepfake Generation and Detection. 25-33.
[23] Xuewei Meng, Chuanmin Jia, Xinfeng Zhang, ShansheWang, and Siwei Ma. 2022. Deformable Wiener Filter for Future Video Coding. IEEE Transactions on Image Processing 31 (2022), 7222-7236.
[24] David Minnen, Johannes Ballé, and George D Toderici. 2018. Joint autoregressive and hierarchical priors for learned image compression. Advances in neural information processing systems 31 (2018).
[25] Maxime Oquab, Pierre Stock, Daniel Haziza, Tao Xu, Peizhao Zhang, Onur Celebi, Yana Hasson, Patrick Labatut, Bobo Bose-Kolanu, Thibault Peyronel, et al. 2021. Low bandwidth video-chat compression using deep generative models. In Proceedings of the IEEE/CVF Conference on Computer Vision and Pattern Recognition. 2388-2397.
[26] Youxin Pang, Yong Zhang, Weize Quan, Yanbo Fan, Xiaodong Cun, Ying Shan, and Dong-ming Yan. 2023. Dpe: Disentanglement of pose and expression for general video portrait editing. In Proceedings of the IEEE/CVF Conference on Computer Vision and Pattern Recognition. 427-436.
[27] Don E Pearson and John A Robinson. 1985. Visual communication at very low data rates. Proc. IEEE 73, 4 (1985), 795-812.
[28] K R Prajwal, Rudrabha Mukhopadhyay, Vinay P Namboodiri, and CV Jawahar. 2020. A lip sync expert is all you need for speech to lip generation in the wild. In Proceedings of the 28th ACM international conference on multimedia. 484-492.
[29] Aliaksandr Siarohin, Stéphane Lathuilière, Sergey Tulyakov, Elisa Ricci, and Nicu Sebe. 2019. First order motion model for image animation. Advances in neural information processing systems 32 (2019).
[30] Gary J Sullivan, Jens-Rainer Ohm, Woo-Jin Han, and Thomas Wiegand. 2012. Overview of the high efficiency video coding (HEVC) standard. IEEE Transactions on circuits and systems for video technology 22, 12 (2012), 1649-1668.
[31] Zhiyao Sun, Yu-Hui Wen, Tian Lv, Yanan Sun, Ziyang Zhang, Yaoyuan Wang, and Yong-Jin Liu. 2023. Continuously controllable facial expression editing in talking face videos. IEEE Transactions on Affective Computing (2023).
[32] Yao Chong Lim Tadas Baltrušaitis, Amir Zadeh and Louis-Philippe Morency. 2018. OpenFace 2.0: Facial Behavior Analysis Toolkit. In Proceedings of the IEEE Conference on Automatic Face and Gesture Recognition. 59-66.
[33] Ting-Chun Wang, Arun Mallya, and Ming-Yu Liu. 2021. One-shot free-view neural talking-head synthesis for video conferencing. In Proceedings of the IEEE/CVF conference on computer vision and pattern recognition. 10039-10049.
[34] ZhaoWang, Bolin Chen, Yan Ye, and ShiqiWang. 2022. Dynamic multi-reference generative prediction for face video compression. In 2022 IEEE International Conference on Image Processing (ICIP). IEEE, 896-900.
[35] Thomas Wiegand, Gary J Sullivan, Gisle Bjontegaard, and Ajay Luthra. 2003. Overview of the H. 264/AVC video coding standard. IEEE Transactions on circuits and systems for video technology 13, 7 (2003), 560-576.
[36] Zipeng Ye, Zhiyao Sun, Yu-HuiWen, Yanan Sun, Tian Lv, Ran Yi, and Yong-Jin Liu. 2022. Dynamic neural textures: Generating talking-face videos with continuously controllable expressions. arXiv preprint arXiv:2204.06180 (2022).
[37] Richard Zhang, Phillip Isola, Alexei A Efros, Eli Shechtman, and Oliver Wang. 2018. The unreasonable effectiveness of deep features as a perceptual metric. In Proceedings of the IEEE conference on computer vision and pattern recognition. 586-595.
[38] Zhichen Zhang, Bolin Chen, Hongbin Lin, Jielian Lin, Xu Wang, and Tiesong Zhao. 2023. ELFIC: A learning-based flexible image codec with rate-distortioncomplexity optimization. In Proceedings of the 31st ACM International Conference on Multimedia. 9252-9261.
[39] Tiesong Zhao, Weize Feng, HongJi Zeng, Yiwen Xu, Yuzhen Niu, and Jiaying Liu. 2022. Learning-based video coding with joint deep compression and enhancement. In Proceedings of the 30th ACM International Conference on Multimedia. 3045-3054.
[40] Jun-Yan Zhu, Taesung Park, Phillip Isola, and Alexei A Efros. 2017. Unpaired image-to-image translation using cycle-consistent adversarial networks. In Proceedings of the IEEE international conference on computer vision. 2223-2232.
[41] Linwei Zhu, Sam Kwong, Yun Zhang, ShiqiWang, and XuWang. 2019. Generative adversarial network-based intra prediction for video coding. IEEE transactions on multimedia 22, 1 (2019), 45-58.
[42] John Cleary and Ian Witten. 1984. Data compression using adaptive coding and partial string matching. IEEE transactions on Communications 32, 4 (1984), 396-402.
[43] Tiankai Hang, Huan Yang, Bei Liu, Jianlong Fu, Xin Geng, and Baining Guo. 2023. Language-guided face animation by recurrent StyleGAN-based generator. IEEE Transactions on Multimedia (2023).
[44] Martin Heusel, Hubert Ramsauer, Thomas Unterthiner, Bernhard Nessler, and Sepp Hochreiter. 2017. Gans trained by a two time-scale update rule converge to a local nash equilibrium. Advances in neural information processing systems 30 (2017).
[45] Jukka Teuhola. 1978. A compression method for clustered bit-vectors. Information processing letters 7, 6 (1978), 308-311.
[46] Wang, K., et al. Mead: A large-scale audio-visual dataset for emotional talking-face generation, in European Conference on Computer Vision. 2020. Springer.
[47] Ramachandran, S. N., et al. Understanding the Generalization of Pretrained Diffusion Models on Out-of-Distribution Data. in Proceedings of the AAAI Conference on Artificial Intelligence. 2024.
[48] Rombach, R., et al. High-resolution image synthesis with latent diffusion models. in Proceedings of the IEEE/CVF conference on computer vision and pattern recognition. 2022.
[49] He, Y., et al., Latent video diffusion models for high-fidelity long video generation. arXiv preprint arXiv:2211.13221, 2022.
[50] Ma, X., et al., Latte: Latent diffusion transformer for video generation. arXiv preprint arXiv:2401.03048, 2024.

1. An encoder for face videos, comprising:
a video codec for compressing an initial frame of a face video sequence;
a compact feature extraction module for extracting a motion code and expression attributes across subsequent inter frames; and
a feature encoding module for feature compression with feature-level inter prediction based on the motion code and the expression attributes,
wherein the compact feature extraction module is configured to project the inter frames into the motion code and the expression attributes, wherein the motion code comprises a motion latent code, and the expression attributes comprise semantic-level expression attributes,
wherein the compact feature extraction module comprises a motion code extractor to project the inter frames into the motion latent code, and an expression attributes extractor to extract attributes of at least one of face elements,
wherein user-specified emotion attributes are further provided to the compact feature extraction module for editable-motion interaction.

2. The encoder of claim 1, wherein the video codec comprises a Versatile Video Coding (VVC) codec.

3. (canceled)

4. (canceled)

5. The encoder of claim 1, wherein the motion latent code comprises a multi-dimensional motion latent code entailing head posture and facial expression.

6. The encoder of claim 1, wherein the expression attributes extractor extracts attributes of at least one of eyes and mouth.

7. (canceled)

8. The encoder of claim 1, wherein the user-specified emotion attributes comprise valence and arousal.

9. The encoder of claim 1, wherein the motion code, the expression attributes and the user-specified emotion attributes are encoded and transmitted by the feature encoding module through residue prediction, quantization and entropy coding.

10. A decoder for face videos encoded by the encoder of claim 1, comprising:
a video codec for decoding a coded initial frame of a face video sequence;
a feature decoding module for reconstructing compact features of subsequent inter frames, the compact features comprising the motion code and the expression attributes;
a disentanglement module for disentangling the motion code into a pose latent code and an expression latent code;
an emotion editing module for manipulation of facial latent code at semantic-level based on the expression latent code and the expression attributes to obtain edited expression latent codes; and
a frame generation module for producing a video with target emotions based on the decoded initial frame, the edited expression latent codes, and the pose latent code.

11. The decoder of claim 10, further comprising a window-based smoothing module for applying on the edited expression latent codes for improving temporal consistency in generated face videos.

12. The decoder of claim 11, wherein the frame generation module is configured to produce the video with target emotions based on the decoded initial frame, smoothed expression latent codes, and the pose latent code.

13. The decoder of claim 10, wherein the disentanglement module comprises multiple perceptron (MLP) layers which include initial MLP layers serving as shared backbone, followed by two heads composed of additional MLP layers.

14. The decoder of claim 10, wherein the emotion editing module is based on conditional continuous normalizing flows (c-CNFs) algorithm to manipulate valence and arousal as desired while preserving the expression attributes.

15. The decoder of claim 14, wherein the c-CNFs algorithm comprises an invertible neural network including forward operating mode and reverse operating mode.

16. The decoder of claim 15, wherein the c-CNFs algorithm is designed for learning temporal evolution of the expression latent code extracted from a real-life frame to a standard expression latent code.

17. The decoder of claim 16, wherein the c-CNFs algorithm is designed to generate the edited expression latent code of the i^{th} frame (cₑₑ(i)), as provided as below,
$${c}_{e e} ( i ) = {c}_{e e} = {c}_{e 0} + {\int }_{{t}_{0}}^{{t}_{1}} {g}_{θ} ( t , {att}^{*} , {c}_{e} ( t ) ) dt ,$$
where att* encompasses both the user-specified emotion attributes and the expression attributes extracted from the original frame.

18. A computer-generated method for encoding face videos, comprising the steps of:
compressing an initial frame of a face video sequence by a video codec;
extracting a motion code and expression attributes across subsequent inter frames by a compact feature extraction module; and
conducting feature compression with feature-level inter prediction based on the motion code and the expression attributes by a feature encoding module,
wherein the step of extracting the motion code and the expression attributes comprises a step of projecting the inter frames into the motion code and the expression attributes, wherein the motion code comprises a motion latent code, and the expression attributes comprise semantic-level expression attributes including attributes of at least one of face elements,
wherein the step of extracting the motion code and expression attributes further comprises a step of providing user-specified emotion attributes to the compact feature extraction module for editable-motion interaction.

19. A computer-generated method for decoding face videos encoded by the method of claim 18, comprising:
decoding a coded initial frame of the face video sequence by the video codec;
reconstructing compact features of subsequent inter frames by a feature decoding module, the compact features comprising the motion code and the expression attributes;
disentangling the motion code into a pose latent code and an expression latent code by a disentanglement module;
manipulating, by an emotion editing module, facial latent code at semantic-level based on the expression latent code and the expression attributes to obtain edited expression latent codes; and
producing, by a frame generation module, a video with target emotions based on the decoded initial frame, the edited expression latent codes, and the pose latent code.

20. The computer-generated method of claim 19, before producing the video with target emotions, further comprising applying a window-based smoothing scheme on the edited expression latent codes for improving temporal consistency in generated face videos.
